(19) United States
(12) Patent Application Publication
(10) Pub. No.: US 2019/0306414 A1
(43) Pub. Date: Oct. 3, 2019

(54) Moving Object Imaging System and Moving Object Imaging Method

(71) Applicant: Hitachi, Ltd., Tokyo (JP)

(72) Inventors: Daisuke MATSUKA, Tokyo (JP); Masahiro MIMURA, Tokyo (JP); Kazuhiko HINO, Tokyo (JP); Takayuki FUJIMURA, Tokyo (JP)

(21) Appl. No.: 16/139,705

(22) Filed: Sep. 24, 2018

(30) Foreign Application Priority Data
Mar. 29, 2018 (JP) 2018-063549

(51) Int. Cl. H04N 5/232; G06K 9/00; G02B 27/09

(52) U.S. Cl. CPC H04N 5/23229; G02B 27/0977; G06K 9/00335; H04N 5/23251

(57) ABSTRACT

Provided is a moving object imaging system including: an imager that captures an image of a moving object and outputs captured image data; a deflector that changes a deflection angle of an optical axis of the imager by rotating a reflecting mirror; a housing that supports the deflector; a posture change detector that detects change in posture of the housing; and a control unit that controls a deflection angle of the deflector in accordance with a detection result of the posture change detector.

### CLAIM OF PRIORITY

The present application claims priority from Japanese Patent application serial no. 2018-063549 filed on Mar. 29, 2018, the content of which is hereby incorporated by reference into this application.

### BACKGROUND OF THE INVENTION

### Field of the Invention

The present invention relates to a moving object imaging system and a moving object imaging method suitable for tracking and imaging of a flying object freely moving in space.

### Background Art

In the related art, there are known apparatuses that capture images of moving objects such flying objects moving in a target region. In order to track a moving object in motion and capture an image thereof, it is necessary to control the optical axis of the camera so as to capture the moving object in the imaging range of the camera. As a control method for directing the optical axis of the camera to the moving object, there is a known method capable of directing the optical axis of the camera to the moving object by driving a plurality of rotatable movable mirrors with motors having different rotation axes.

This technique is disclosed in, for example, JP-A-H10-136234. In the abstract of the document, the following description is given.

“A light transmissive window W1 is provided in a non-light-transmissive housing B1. In addition, in the non-light-transmissive housing B1, an imaging apparatus C1, an azimuth angle rotatable reflecting mirror M1, a tilt angle rotatable reflecting mirror M2, and motors m1 and m2 rotating the mirrors M1 and M2 are disposed. The rays I from the field of view of a subject pass through the window W1, and are then regularly reflected by the mirror M1, and reflected again by the mirror M2. Thereby, an image of the subject returns to an erect image, and the erect image of the subject is incident into the imaging apparatus C1.”

There is also known a technique of detecting change in posture of a camera due to disturbance or the like with an acceleration sensor and correcting the inclination of the captured image. For example, in the abstract of JP-A-2017-225039, the following description is given. “An imaging apparatus includes: an optical system; an element that outputs an image, which is incident through the optical system, as image data; an acceleration sensor that outputs a signal representing acceleration in three axial directions; an angular velocity sensor that outputs a signal representing an angular velocity around the three axes; and a circuit that processes the image data. The circuit corrects a low frequency component of the inclination of the image on the basis of the acceleration, and performs correction processing of correcting a high frequency component of the inclination of the image on the basis of the angular velocity.”

### SUMMARY OF THE INVENTION

The method of installing the surveillance camera is not explicitly described in JP-A-H10-136234, in order to install the camera at a desired place. However, considering the ease of installation and movement and the degree of freedom, the camera is not strongly fixed to the ground or a structural member, but mostly fixed by using a simple supporting apparatus such as a tripod. In a case of adopting such a simple installation mode, there is a possibility that the posture of the surveillance camera changes due to disturbance such as wind or vehicle vibration in the outdoors. In addition, even in the indoor, the posture of the surveillance camera may change due to disturbance such as floor vibration caused by walking of a person. Then, especially when high-ratio zoom imaging is performed, blurring synchronized with disturbance may be mixed in the captured image data.

In JP-A-2017-225039, in a case where the posture of the camera changes due to disturbance, the inclination of the image data is corrected through image processing on the basis of acceleration, such that blurring is suppressed. However, since the inclination is corrected through image processing, it is difficult to cope with the change in posture of the movable mirror due to the influence of the disturbance which occurs in the camera having the movable mirror as in JP-A-H10-136234.

The present invention has been made in consideration of the above, and it is an object of the present invention to provide a moving object imaging system and a moving object imaging method capable of preventing blurring from being mixed in captured image data by controlling the posture of the movable mirror in accordance with disturbance even in a case where a camera using a movable mirror (reflecting mirror) is not fixed to the ground or a structural member and is installed on a simple supporting apparatus such as a tripod without a vibration damping apparatus.

In order to achieve the above-mentioned object, in the present invention, a moving object imaging system of the present invention includes: an imager that captures an image of a moving object and outputs captured image data; a deflector that changes a deflection angle of an optical axis of the imager by rotating a reflecting mirror; a housing that supports the deflector; a posture change detector that detects change in posture of the housing; and a control unit that controls a deflection angle of the deflector in accordance with a detection result of the posture change detector.

According to the present invention, even in the case where the camera using the movable mirror (reflecting mirror) is not fixed to the ground surface or the structural member and the camera is installed on a simple supporting apparatus such as a tripod without the vibration damping apparatus, it is possible to prevent the blurring from being mixed in the captured image data by controlling the posture of the movable mirror in accordance with disturbance.

### BRIEF DESCRIPTION OF THE DRAWINGS

FIG. 1 is a schematic diagram of a moving object imaging system according to Example 1.

FIG. 2 is a functional block diagram of an imaging apparatus control unit, a deflector, and the like according to Example 1.

FIG. 3 is a schematic diagram illustrating a control method of the deflector of Example 1.

FIG. 4 is a schematic diagram of a moving object imaging system according to Example 2.

FIG. 5 is a functional block diagram of an imaging apparatus control unit, a deflector, and the like according to Example 2.

FIG. 6 is a schematic diagram illustrating image processing in the image processing device according to Example 2.

FIG. 7 is a schematic diagram of a moving object imaging system according to Example 3.

FIG. 8 is a functional block diagram of an imaging apparatus control unit, a deflector, and the like according to Example 3.

FIGS. 9A to 9C are schematic diagrams for explaining calculation in the correction amount calculation unit of Example 3.

FIG. 10 is a schematic diagram for explaining image processing in the image processing device according to Example 3.

### DETAILED DESCRIPTION OF THE INVENTION

Hereinafter, examples of the present invention will be described. In the following examples, for the sake of convenience, description will be given with reference to a plurality of examples. Unless otherwise stated, the examples do not unrelate to one another such that one example is a part of another example, or a modification example, details, supplementary explanation, or the like of all examples.

### Example 1

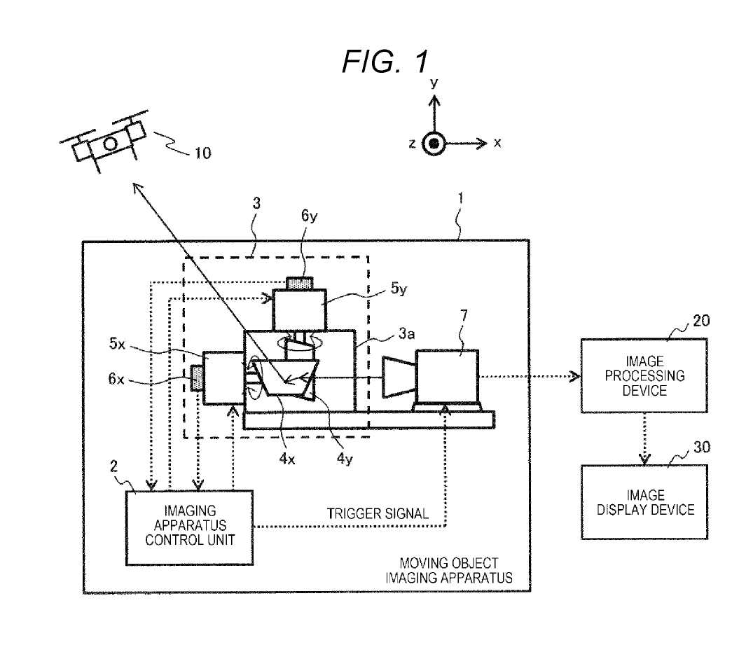

A moving object imaging system according to Example 1 of the present invention will be described with reference to FIGS. 1 to 3. In the following description, an example will be described in which the moving object as the tracking imaging target is the flying object 10 such as a drone that freely fly in the three-dimensional space. However, a vehicle, a person, a ship, and the like moving on the plane may be a tracking imaging target.

FIG. 1 is a schematic diagram illustrating constituent elements of the moving object imaging system of the present example together with the flying object 10 which is a tracking imaging target. The constituent elements include a moving object imaging apparatus 1, an image processing device 20 such as a personal computer that processes the received captured image data 8, and an image display device 30 such as a liquid crystal display that displays display data 8a after image processing. The moving object imaging apparatus 1 is installed in a simple supporting apparatus such as a tripod which is not shown. In FIG. 1, the right direction is the positive direction of the x axis, the up direction is the positive direction of they axis, the front direction is the positive direction of the z axis, and the dotted lines connecting the respective elements indicate the signal lines.

In the moving object imaging apparatus 1 shown here, the imager 7 and the deflection unit 3 are provided on the base of a rigid body such that the optical axis of the imager 7 is parallel to the x axis and the optical axis of the imager 7 can be deflected in the vertical direction or the lateral direction by the deflection unit 3. The moving object imaging apparatus 1 also includes an imaging apparatus control unit 2 that controls the imaging timing and the imaging magnification of the imager 7, the deflection angle in the deflection unit 3, and the like. Thus, the captured image data 8, which is obtained by tracking the flying object 10 through the control, is output from the imager 7.

In order to track the optical axis of the imager 7 on the flying object 10, the deflection unit 3 includes a reflecting mirror 4x that deflects the optical axis in the vertical direction, and a reflecting mirror 4y that deflects the optical axis in the lateral direction, in a housing 3a made of a rigid body such as a steel plate. In addition, the deflection unit 3 includes a deflector 5x that rotates the reflecting mirror 4x around the x axis, on the side surface of the housing 3a, and a deflector 5y that rotates the reflecting mirror 4y around the y axis, on the upper surface of the housing 3a. It should be noted that the reflecting mirrors 4x and 4y and the deflectors 5x and 5y may be collectively referred to as a deflection unit. Further, an angular velocity sensor 6x is disposed on the rotation axis of the deflector 5x, and an angular velocity sensor 6y is disposed on the rotation axis of the deflector 5y. By using the angular velocity sensors 6x and 6y, in a case where the posture of the deflection unit 3 changes due to the influence of disturbance such as vibration or wind, the amount of rotation Δθₓ around the x axis can be detected on the basis of the angular velocity ωₓ which is output from the angular velocity sensor 6x, and the amount of rotation Δθ_{y} around the y axis can be detected on the basis of the angular velocity ω_{y} which is output from the angular velocity sensor 6y. In the following description, the two reflecting mirrors may be collectively referred to as the reflecting mirror 4, the two deflectors may be collectively referred to as a deflector 5, and the two angular velocity sensors may be collectively referred to as an angular velocity sensor 6.

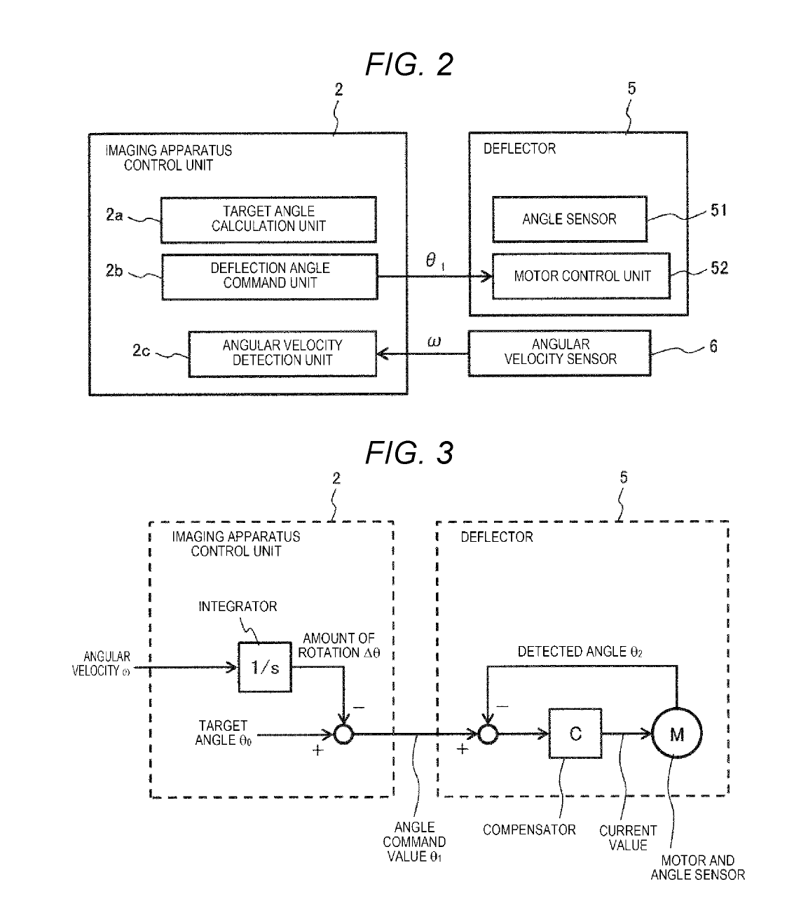

FIG. 2 is a schematic diagram illustrating details of the imaging apparatus control unit 2, the deflector 5, and the angular velocity sensor 6 of the present example. Since the deflection unit 3 of the present example is provided with two reflecting mirrors 4x and 4y, the configuration of FIG. 2 is necessary for each reflecting mirror. However, since the contents of the deflection angle control of both reflecting mirrors are the same, in the following description, the configuration of FIG. 2 which is representative of both will be described as an example.

In addition to a motor (not shown) such as a galvano motor capable of angle control, the deflector 5 includes an angle sensor 51 such as an encoder that detects the deflection angle of the motor shown in FIG. 2, and a motor control unit 52 that supplies the motor with drive power.

The imaging apparatus control unit 2 further includes a target angle calculation unit 2a that calculates a target deflection angle θ₀ of the reflecting mirror 4 necessary for tracking the flying object 10 and capturing an image of the flying object 10 at the center of the captured image data 8, a deflection angle command unit 2b that outputs a deflection angle command value θ₁ based on a target deflection angle θ₀ to the motor control unit 52 of the deflector 5, an angular velocity detection unit 2c that detects the angular velocity ω from the output of the angular velocity sensor 6, and an imager control unit (not shown) that controls the imaging timing of the imager 7. The functions of the respective units in the imaging apparatus control unit 2 are realized by loading a program stored in an auxiliary storage device such as a hard disk or the like of the imaging apparatus control unit 2 on a main storage device such as a semiconductor memory and the like and causing a computing device such as a CPU to execute the program. However, in the following description, such well-known operations will be appropriately omitted, and description thereof will be given.

FIG. 3 is a diagram for explaining processing, which is mainly executed by the deflection angle command unit 2b, in the imaging apparatus control unit 2, and processing, which is mainly executed by the motor control unit 52, in the deflector 5. In a case where the angular velocity ω which is the output of the angular velocity sensor 6 is input to the angular velocity detection unit 2c, as shown in FIG. 3, the integration processing is performed on the angular velocity ω, and the amount of rotation Δθ around the axis due to the influence of disturbance such as wind is calculated. Thereafter, the deflection angle command unit 2b subtracts the amount of rotation Δθ corresponding to the influence of the disturbance from the target deflection angle θ₀ calculated by the target angle calculation unit 2a, and outputs this amount as the deflection angle command value θ₁ to the deflector 5.

In the deflector 5, a value obtained by subtracting a motor rotation angle θ₂ detected by the angle sensor 51 from the received deflection angle command value θ₁ is input to a compensator C. Then, a current value corresponding to the difference between the deflection angle command value θ₁ and the motor rotation angle θ₂ is output from the compensator C, and the motor rotates in accordance with the current value. As a result, the reflecting mirror 4 is set at a predetermined angle designated by the imaging apparatus control unit 2.

As described above, in the present example, the deflector 5 is controlled by using the deflection angle command value θ₁ that cancels the amount of rotation Δθ due to disturbance such as wind. With such a configuration, even in a case where the posture of the deflection unit 3 changes due to the influence of disturbance, the deflection angle of the reflecting mirror 4 is sequentially corrected in a direction to cancel out the influence of the disturbance. As a result, the influence of disturbance can be suppressed in the captured image data 8 of the imager 7, and the captured image data 8 can be made free from blurring.

As described above, according to the present example, even in a case where the moving object imaging apparatus using the deflection unit is installed on the simple supporting apparatus such as a tripod, it is possible to prevent blurring from being mixed in the captured image data by controlling the posture of the reflecting mirror in the deflection unit in accordance with disturbance such as wind.

### Example 2

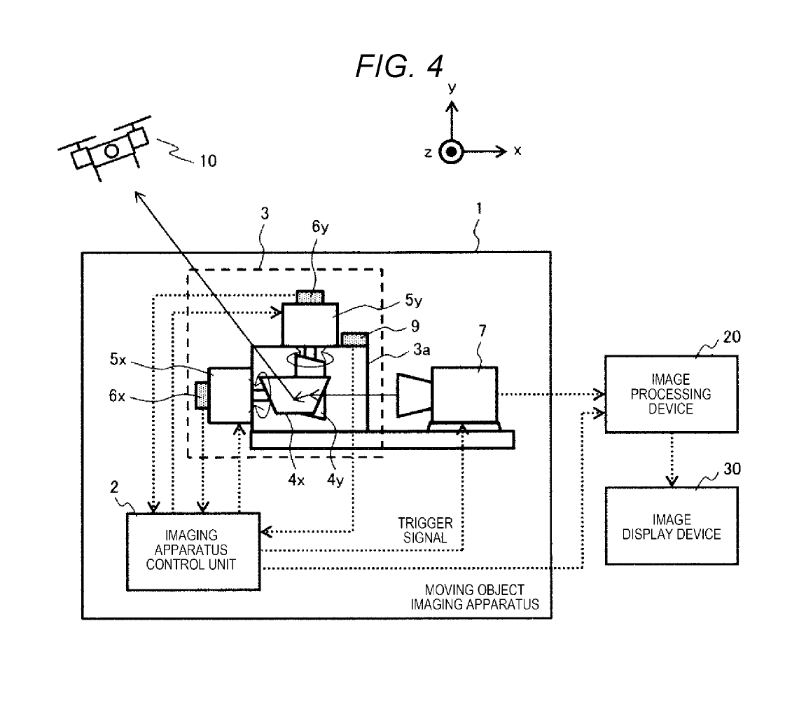

Next, a moving object imaging system according to Example 2 of the present invention will be described with reference to FIGS. 4 to 6. It should be noted that redundant description of commonalities with Example 1 will be omitted.

In the moving object imaging system of Example 1, change in posture around the rotation axis of the reflecting mirror 4 is detected as the amount of rotation Δθ by using the angular velocity sensor 6. However, in the configuration of the moving object imaging system of the present example, by using an acceleration sensor 9 to be described later, the change in posture due to the movement of the housing 3a of the deflection unit 3 is detected as an amount of shift Δ, and display data 8a to be displayed on the image display device 30 is extracted on the basis of the amount of shift Δ.

FIG. 4 is a schematic diagram of the moving object imaging apparatus 1, the image processing device 20, and the image display device 30 constituting the moving object imaging system of the present example. As shown here, a configuration of the moving object imaging system of the present example is different from the configuration of Example 1 shown in FIG. 1 in the following point. The acceleration sensor 9, which is provided on the housing 3a of the deflection unit 3, and a signal line are added. The signal line connects the imaging apparatus control unit 2 and the image processing device 20.

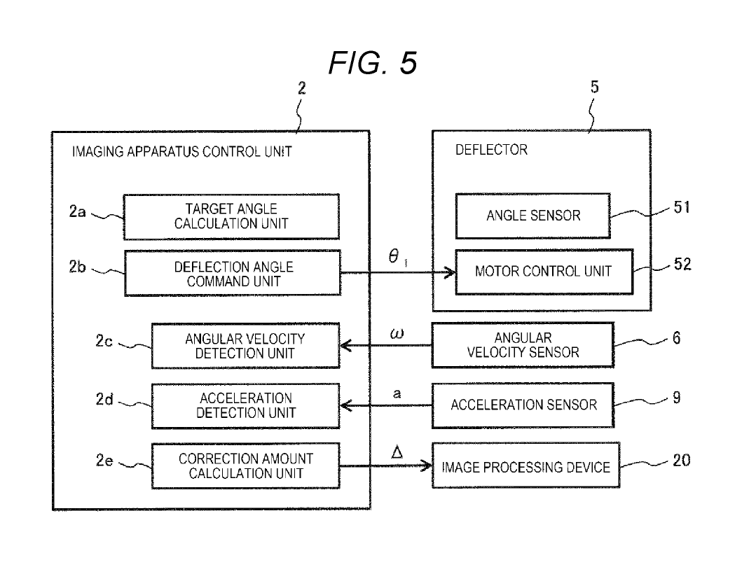

FIG. 5 is a schematic diagram illustrating details of the imaging apparatus control unit 2, the deflector 5, the angular velocity sensor 6, the acceleration sensor 9, and the image processing device 20 according to the present example. As shown here, a configuration of the imaging apparatus control unit 2 of the present example is different from the configuration of Example 1 shown in FIG. 2 in the following point. The acceleration detection unit 2d, which detects an acceleration a from the output of the acceleration sensor 9, and a correction amount calculation unit 2e, which outputs the amount of shift Δ necessary for correcting the captured image data 8, are added to the image processing device 20.

The acceleration sensor 9 of the present example is capable of individually detecting accelerations a (aₓ, a_{y}, a_{z}) in three directions applied in a case where the deflection unit 3 moves due to disturbance such as wind. Then, the correction amount calculation unit 2e of the imaging apparatus control unit 2 performs the integration processing twice on the acceleration a in each direction, thereby calculating the amount of movement of the deflection unit 3 due to disturbance (amount of shift Δ (Δₓ, Δ_{y}, Δ_{z})).

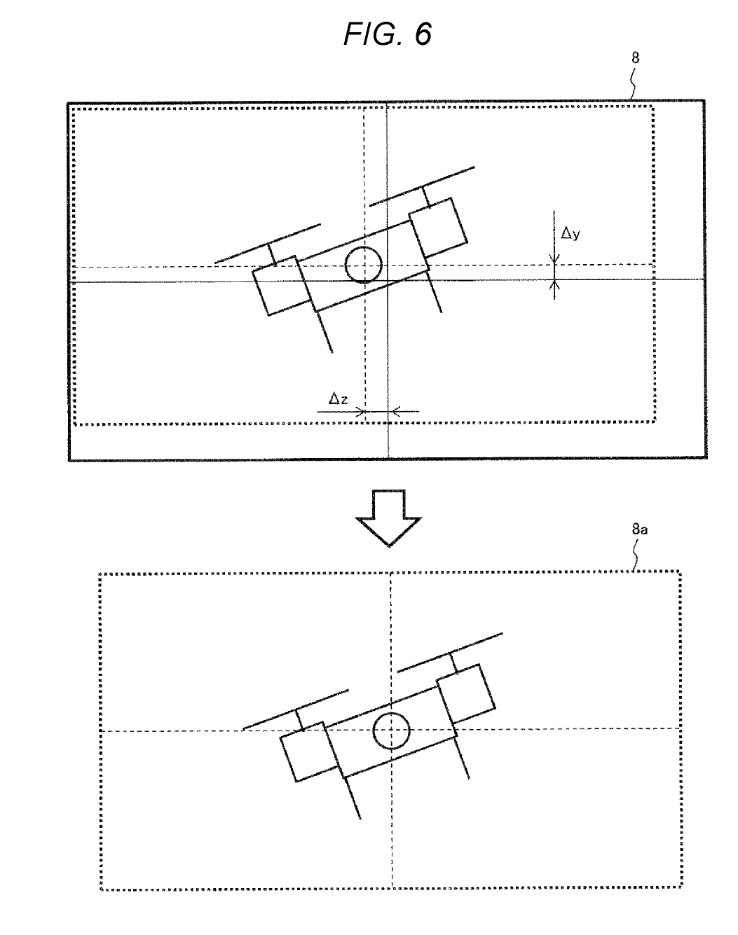

Next, a processing method of the captured image data 8 using the amount of shift Δ will be described with reference to FIG. 6. In FIG. 6, the upper side shows an example of the captured image data 8 when the imager 7 captures a zoomed image of the flying object 10, and the lower side shows an example of the display data 8a displayed on the image display device 30 on the basis of the captured image data 8. As clearly seen from a comparison between both sides of the figure, the captured image data 8 is larger than the display data 8a (for example, the former is 1350×900 pixels and the latter is 1280×720 pixels). Therefore, a partial region of the captured image data 8 can be cut out to be the display data 8a.

As described above, the amount of shift Δ, which is output by the correction amount calculation unit 2e, corresponds to the amount of movement of the deflection unit 3 due to disturbance. Thus, in a case where the amount of shift Δ is output, it can be presumed that the flying object 10 on the captured image data 8 is at a position which is shifted by the amount of shift Δ from a position predetermined by the imaging apparatus control unit 2.

In order to correct this shift, the image processing device 20 of the present example extracts a region with a predetermined size shifted by an amount of shift, which is input from the correction amount calculation unit 2e, Δ from the center of the captured image data 8 on the basis of the amount of shift Δ, and transmits the region as display data 8a to the image display device 30. Through this processing, the display data 8a corrected for the influence of the amount of shift Δ due to the disturbance can be displayed on the image display device 30. Thus, even in a case where the display data 8a is a moving image, the influence of blurring due to disturbance can be reduced.

According to the moving object imaging apparatus of the present example described above, it is possible to suppress the disturbance influence through the control shown in FIG. 3 performed by the deflection angle command unit 2b or the like as in Example 1. In addition, it is possible to suppress the influence of disturbance even in the combination of the correction amount calculation unit 2e and the image processing device 20. Therefore, the quality of the display data 8a displayed on the image display device 30 can be improved as compared with Example 1.

### Example 3

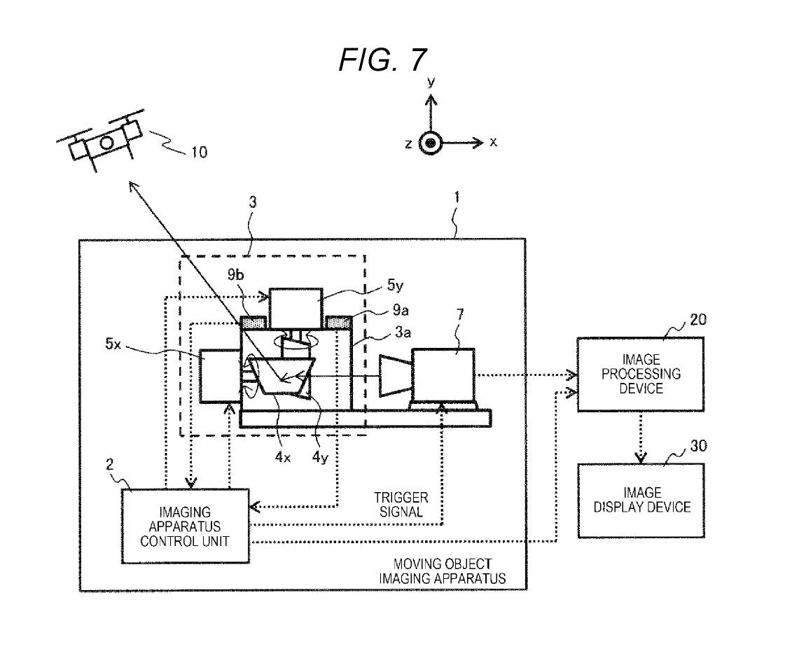

Next, a moving object imaging system according to Example 3 of the present invention will be described with reference to FIGS. 7 to 9. It should be noted that redundant description of commonalities with Example 1 is omitted.

In Examples 1 and 2, the deflection angle of the reflecting mirror 4 is corrected on the basis of the amount of rotation Δθ around the axis of the deflection unit 3 detected by the angular velocity sensor 6, and in Example 2, the deflection detected by the acceleration sensor 9 On the basis of the amount of shift Δ of the deflection unit 3, the display data 8a was extracted from the captured image data 8.

On the other hand, in the moving object imaging system of the present example, two acceleration sensors 9 are provided on the surface of the housing 3a of the deflection unit 3. On the basis of these outputs, the amount of rotation Δθ around the axis of the deflection unit 3 and the amount of shift Δ are calculated. Thereby, even in a configuration in which the angular velocity sensor 6 is omitted, control for coping with disturbance according to Examples 1 and 2 can be executed.

FIG. 7 is a schematic diagram of the moving object imaging apparatus 1, the flying object 10, the image processing device 20, and the image display device 30 according to the present example. As shown here, in the present example, instead of the angular velocity sensors 6x and 6y and the acceleration sensor 9 of Example 2 shown in FIG. 4, the two acceleration sensors 9a and 9b are provided. It should be noted that the two acceleration sensors 9a and 9b can be provided at an optional position on the surface of the housing 3a, and in the example of FIG. 7, both acceleration sensors are arranged in the x axis direction. Hereinafter, both acceleration sensors are disposed with a distance L therebetween in the z axis direction (the front-to-back direction of the drawing).

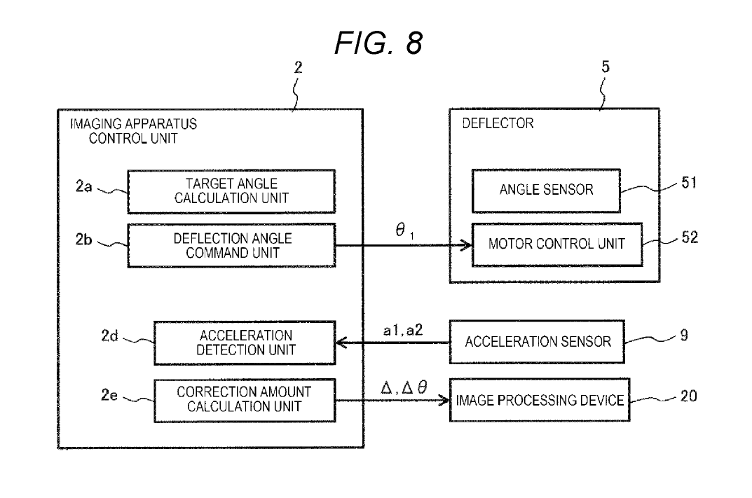

FIG. 8 is a schematic diagram illustrating details of the imaging apparatus control unit 2, the deflector 5, the acceleration sensor 9, and the image processing device 20 according to the present example. As shown here, in the imaging apparatus control unit 2 of the present example, the angular velocity sensor 6 and the angular velocity detection unit 2c are removed from the configuration of Example 2 shown in FIG. 5. Since the two acceleration sensors 9a and 9b are provided, two accelerations a1 and a2 are input to the imaging apparatus control unit 2, and the amount of shift Δ and the amount of rotation Δ are output to the image processing device 20 from the correction amount calculation unit 2e.

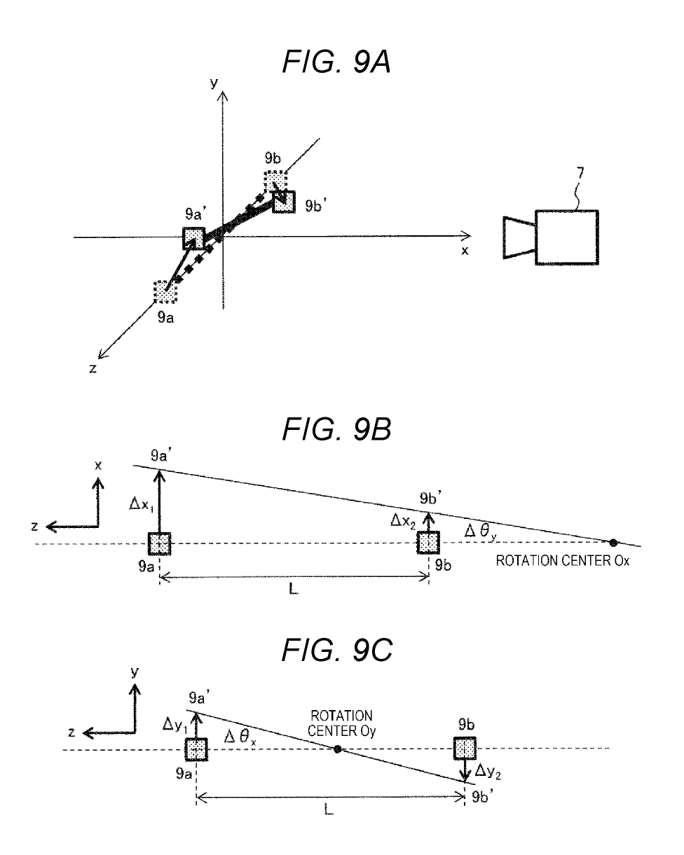

Next, a method of calculating the amount of shift Δ and the amount of rotation Δθ of the deflection unit 3 through the correction amount calculation unit of the imaging apparatus control unit 2 will be described with reference to FIG. 9 and the like. As shown in FIG. 9A, it is assumed that the posture of the deflection unit 3 changes due to disturbance, such that the acceleration sensor 9a on the housing 3a moves to a position 9a′, and the acceleration sensor 9b moves to a position 9b′. In this case, in a case where the accelerations a1 and a2 which are the outputs of the respective acceleration sensors are input to the acceleration detection unit 2d, the integration processing is applied twice to each of the accelerations a1 and a2. Thereby, it is possible to calculate the amount of movement in each direction of x, y, and z at the installation point of each acceleration sensor. Hereinafter, it is assumed that the amount of movement of the acceleration sensor 9a is Δ₁ (Δx₁, Δy₁, Δz₁) and the amount of movement of the acceleration sensor 9b is Δ₂ (Δx₂, Δy₂, Δz₂).

FIG. 9B is an explanatory diagram for explaining a method of calculating the amount of rotation Δθ_{y} of the straight line connecting the acceleration sensors 9a and 9b projected on the xz plane. FIG. 9C is an explanatory diagram for explaining a method of calculating the amount of rotation Δθₓ of the straight line connecting the acceleration sensors 9a and 9b projected on the yz plane. As clearly seen from these drawings, the amount of rotations Δθₓ and Δθ_{y} can be obtained by the following (Expression 1).

$$\begin{matrix}Expression 1 & \\ ( \begin{matrix}{Δθ}_{x} \\ {Δθ}_{y}\end{matrix} ) = ( \begin{matrix}{tan}^{- 1} ( \frac{Δ {y}_{1} - Δ {y}_{2}}{L} ) \\ {tan}^{- 1} ( \frac{Δ {x}_{1} - Δ {x}_{2}}{L} )\end{matrix} ) & ( Expression 1 )\end{matrix}$$

The amount of rotation Δθ obtained by the correction amount calculation unit 2e on the basis of Equation 1 is equivalent to the amount of rotation Δθ of the deflection unit 3 in FIG. 3 of Example 1. Thus, according to the configuration of the present example, even in a case where the angular velocity sensor 6 of Example 1 is omitted, it is possible to realize the same control of the deflection angle of the reflecting mirror 4 as in Example 1.

In addition to the image processing in consideration of the amount of shift Δ as in Example 2, the present example also executes image processing in which the amount of rotation Δθ of the deflection unit 3 is considered. As shown in FIG. 9A, in the case of the present example in which the optical axis of the imager 7 and the x axis are parallel to each other, the captured image data 8 of the imager 7 is affected by the amount of rotation Δθₓ around the x axis of the deflection unit 3. Therefore, in the image processing device 20, the influence of the inclination of the deflection unit 3 due to disturbance can be removed by applying the correction processing to the captured image data 8 on the basis of the amount of rotation Δθₓ which is input from the correction amount calculation unit 2e.

In the image processing device 20 of the present example, in a manner similar to that of Example 2, the image processing in which the amount of shift Δ is considered is performed, and then the display data 8a is determined. In the present example, unlike Example 2, since the outputs of the two acceleration sensors 9 are obtained, the correction amount calculation unit 2e calculates the amount of shift Δ used for the image correction processing on the basis of the following (Expression 2).

$$\begin{matrix}Expression 2 & \\ ( \begin{matrix}Δ y \\ Δ z\end{matrix} ) = ( \begin{matrix}\frac{Δ {y}_{1} + Δ {y}_{2}}{2} \\ \frac{Δ {z}_{1} + Δ {z}_{2}}{2}\end{matrix} ) & ( Expression 2 )\end{matrix}$$

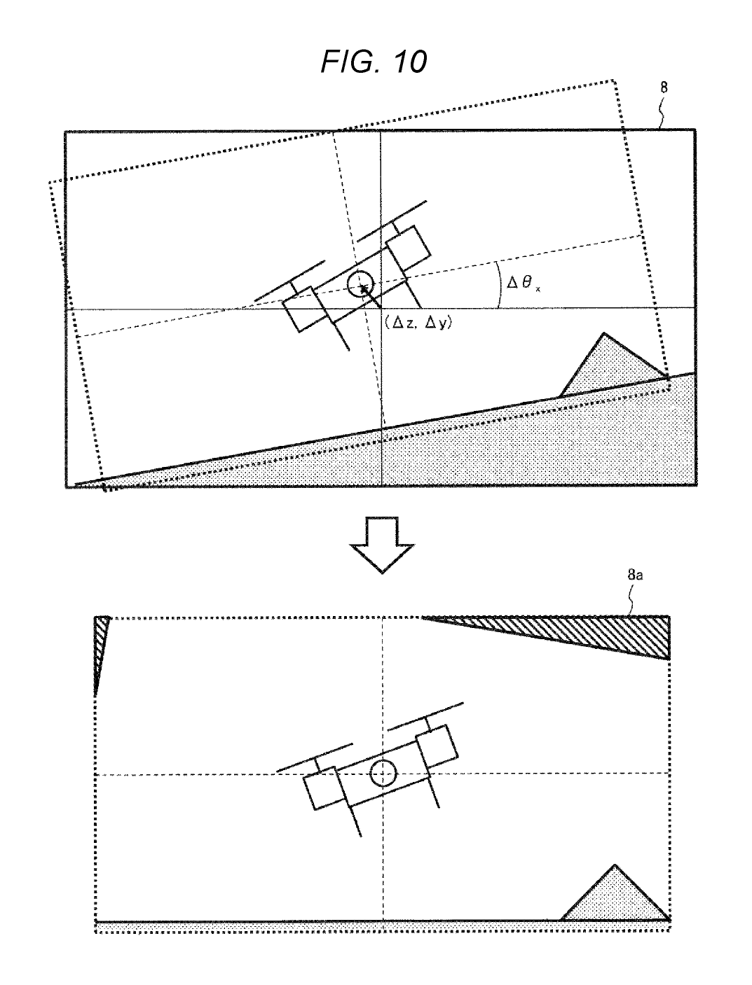

FIG. 10 shows an example of a process from when the image processing is performed on the captured image data 8 to when the display data 8a is obtained on the basis of the amount of rotation Δθₓ, the amount of shift Δy, and the amount of shift Δz calculated by the correction amount calculation unit 2e. First, as shown in the upper side of FIG. 10, a position shifted by (Δz, Δy) from the center position of the captured image data 8 is specified, and an area tilted by an amount corresponding to the amount of rotation Δθₓ around the specified position is extracted. Next, by applying correction processing to make this region horizontal, it is possible to display, on the image display device 30, the display data 8a from which the influence of disturbance has been removed, as shown in the lower side of FIG. 10.

According to the moving object imaging apparatus 1 of the present example described above, in addition to the effects obtained in Examples 1 and 2, the influence of the inclination of the deflection unit 3 due to disturbance can be removed from the display data 8a displayed on the image display device 30. Therefore, the display data 8a with higher quality can be displayed.

It should be noted that the present invention is not limited to the above-mentioned examples, but includes various modification examples. For example, the above-mentioned examples have been described in detail in order to explain the present invention in an easy-to-understand manner, and are not necessarily limited to those having all the configurations described. Further, a part of the configuration of one example may be replaced by the configuration of another example, and the configuration of one example may be added to the configuration of another example. Further, in the configuration of each example, addition of another configuration, deletion, and replacement may be possible.

What is claimed is:

1. A moving object imaging system comprising:
an imager that captures an image of a moving object and outputs captured image data;
a deflector that changes a deflection angle of an optical axis of the imager by rotating a reflecting mirror;
a housing that supports the deflector;
a posture change detector that detects change in posture of the housing; and
a control unit that controls a deflection angle of the deflector in accordance with a detection result of the posture change detector.

2. The moving object imaging system according to claim 1,
wherein the posture change detector is an angular velocity sensor that detects change in angular velocity.

3. The moving object imaging system according to claim 2,
wherein the angular velocity sensor is disposed on a rotation axis of the deflector, and detects an angular velocity around the rotation axis.

4. The moving object imaging system according to claim 1,
wherein the posture change detector is an acceleration sensor that detects change in acceleration.

5. The moving object imaging system according to claim 4, further comprising:
an image processing device that generates display data on the basis of the captured image data; and
an image display device that displays the display data,
wherein the image processing device cuts out a partial region of the captured image data as the display data on the basis of an amount of shift of the housing which is calculated on the basis of the acceleration detected by the acceleration sensor.

6. The moving object imaging system according to claim 1,
wherein the posture change detector is two acceleration sensors that detect change in acceleration.

7. The moving object imaging system according to claim 6, further comprising:
an image processing device that generates display data on the basis of the captured image data; and
an image display device that displays the display data,
wherein the image processing device generates the display data by performing rotation processing on the captured image data on the basis of an amount of rotation of the housing which is calculated on the basis of two accelerations detected by the two acceleration sensors.

8. A moving object imaging method for a moving object imaging system including an imager that captures an image of a moving object and outputs captured image data, a deflector that changes a deflection angle of an optical axis of the imager by rotating a reflecting mirror, a housing that supports the deflector, and a posture change detector that detects change in posture of the housing, the method comprising:
controlling a deflection angle of the deflector in accordance with a detection result of the posture change detector.

9. The moving object imaging method according to claim 8,
wherein the moving object imaging system further includes an image display device that displays the display data which is generated on the basis of the captured image data, and
wherein the display data displayed on the image display device is obtained by cutting out a partial region of the captured image data on the basis of an amount of shift of the housing which is calculated on the basis of an acceleration detected by the posture change detector.

10. The moving object imaging method according to claim 8,
wherein the moving object imaging system further includes an image display device that displays the display data which is generated on the basis of the captured image data, and
wherein the display data displayed on the image display device is obtained by performing rotation processing on the captured image data on the basis of an amount of rotation of the housing which is calculated on the basis of an acceleration detected by the posture change detector.
